(19) United States
(12) Patent Application Publication
(10) Pub. No.: US 2024/0169447 A1
(43) Pub. Date: May 23, 2024

(54) System and Method for Performing Marriage in a Metaverse

(71) Applicants: Joseph Gish, Chino Hills, CA (US); Julie Gish, Chino Hills, CA (US)

(72) Inventors: Joseph Gish, Chino Hills, CA (US); Julie Gish, Chino Hills, CA (US)

(21) Appl. No.: 17/992,724

(22) Filed: Nov. 22, 2022

(51) Int. Cl. G06Q 50/00; G06Q 50/18

(52) U.S. Cl. CPC G06Q 50/01; G06Q 50/18

(57) ABSTRACT

A blockchain-based marriage system and method are disclosed for performing a marriage in a metaverse. The system and method utilize a user database that includes a first user ID associated with the first user, a second user ID associated with the second user, and a marriage officiant ID associated with a marriage officiant. A system server performs the following steps: receiving a marriage report; generating a marriage data entry in response to the marriage report, the marriage data entry including the first and second user IDs, the marriage officiant ID; and adding the marriage data entry to a blockchain.

### BACKGROUND OF THE INVENTION

### Field of the Invention

This invention relates generally to marriage, and more particularly to system and method for marriage in a virtual world such as a metaverse.

### Description of Related Art

Traditional marriages are typically performed in person, at a physical location such as a church, and officiated by a marriage officiant such as a priest or other official (e.g., a secular official such as a judge, an ordained minister, etc.). A marriage license is prepared beforehand, and a marriage license is generated at the end, typically by a government agency.

Since marriages are typically dependent upon meeting together in a certain physical location, and are dependent upon approval by a government agency, there are many limitations placed upon obtaining a marriage. For example, some couples may not be able to physically meet for a wedding, either due to distance, societal disruptions such as pandemics, and other factors. They may also be limited by local laws, religious practices, and restrictions based upon sexual orientation, assigned genders, and other factors.

There is a long-felt need for a system that allows any people to marry, regardless of physical location, and regardless of societal rules, laws, and norms that otherwise limit access to marriage. The present invention fulfills these needs and provides further advantages as described in the following summary.

### SUMMARY OF THE INVENTION

The present invention teaches certain benefits in construction and use which give rise to the objectives described below.

The present invention provides a blockchain-based marriage system and method for performing a marriage in a metaverse. The system and method utilize a user database that includes a first user ID associated with the first user, a second user ID associated with the second user, and a marriage officiant ID associated with a marriage officiant. A system server performs the following steps: receiving a marriage report; generating a marriage data entry in response to the marriage report, the marriage data entry including the first and second user IDs, the marriage officiant ID; and adding the marriage data entry to a blockchain.

In one embodiment, the system also generates an NFT that includes the marriage data entry, and transmits the NFT to the first and second users. The system may also transmit the NFT to a government office or official, such as a county clerk, for recordation as a marriage.

A primary objective of the present invention is to provide a blockchain-based marriage system and method having advantages not taught by the prior art.

Another objective is to provide a blockchain-based marriage system and method that enables users to be married without constraints of physical location.

Another objective is to provide a blockchain-based marriage system and method that enables users to be married without constraints of local laws, religious practices, and restrictions based upon sexual orientation, assigned genders, and other factors,

A further objective is to provide a blockchain-based marriage system and method that outputs clear and verifiable evidence of a marriage that is protected by blockchain technology for verification, security, and protection.

A further objective is to provide a blockchain-based marriage system and method that outputs documentation of a marriage that includes a timestamp so that the date of a marriage is established and verifiable.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention.

FIG. 1 is a block diagram of one embodiment of a blockchain-based marriage system that embodies the present invention.

FIG. 2 is a block diagram of a blockchain generated by the blockchain-based marriage system of FIG. 1.

FIG. 3 is one embodiment of user data captured for each user.

FIG. 4 is one embodiment of a marriage data entry that may be incorporated in the blockchain of FIG. 2.

FIG. 5 is a screen capture of a metaverse in which a marriage is being performed.

FIG. 6 is a flow diagram illustrating the operation of the blockchain-based marriage system, in one embodiment of the present invention.

### DETAILED DESCRIPTION OF THE INVENTION

The above-described drawing figures illustrate the invention, a system and method for performing marriage in a metaverse.

For purposes of this application, the term “metaverse” refers to any form of computer generated virtual world in which people in the form of digital avatars are able to have virtual interactions.

For purposes of this application, the term “NFT” refers to any form of non-fungible token that is a unique digital identifier that is recorded in a blockchain.

For purposes of this application, the terms “computer,” “computer device,” “server,” and similar terms, refer to a device and/or system of devices that include at least one computer processor, and some form of computer memory having a capability to store data. The computer may comprise hardware, software, and firmware for receiving, storing, and/or processing data as described below. For example, a computer may comprise any of a wide range of digital electronic devices, including, but not limited to, a server, a desktop computer, a laptop, a smart phone, a tablet, or any form of electronic device capable of functioning as described herein.

The term “computer processor” as used herein refers to an electrical component that performs operations on an external data source, such as a computer memory, typically in the form of a microprocessor, although any equivalent structure may be used.

The term “computer memory” as used herein refers to any tangible, non-transitory storage that participates in providing instructions to a processor for execution. Such a medium may take many forms, including but not limited to, non-volatile media, volatile media, and any equivalent media known in the art. Non-volatile media includes, for example, ROM, magnetic media, and optical storage media. Volatile media includes, for example, DRAM, which typically serves as main memory. Common forms of computer memory, include, for example, hard drives and other forms of magnetic media, optical media such as CD-ROM disks, as well as various forms of RAM, ROM, PROM, EPROM, FLASH-EPROM, solid state media such as memory cards, and any other form of memory chip or cartridge, or any other medium from which a computer can read. While several examples are provided above, these examples are not meant to be limiting, but illustrative of several common examples, and any similar or equivalent devices or systems may be used that are known to those skilled in the art.

The term “database” as used herein, refers to any form of one or more (or combination of) relational databases, object-oriented databases, hierarchical databases, network databases, non-relational (e.g. NoSQL) databases, document store databases, in-memory databases, programs, tables, files, lists, or any form of programming structure or structures that function to store data as described herein.

The term “network” is defined to include any device or system for communicating information from one computer device to another. For example, a global computer network (e.g., the Internet) may be used, including any form of local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, enabling messages to be sent from one to another. In addition, communication links within LANs typically include twisted wire pair or coaxial cable, while communication links between networks may utilize analog telephone lines, full or fractional dedicated digital lines, Digital Subscriber Lines (DSLs), wireless links including satellite links, or other communications links known to those skilled in the art. The network may further include any form of wireless network, including cellular systems, WLAN, Wireless Router (WR) mesh, or the like. Access technologies such as 3G, 4G, 5G, and future access networks may enable wide area coverage for mobile devices. In essence, the wireless network may include any wireless communication mechanism known in the art by which information may travel between computers of the present system.

The term “user” as used herein, refers to any individual, or computer functioning on behalf of the individual, who may be interested in getting married.

The term “marriage officiant” as used herein, refers to any individual, or computer functioning on behalf of the individual or other form of legal entity, that is capable of performing a marriage ceremony. The marriage officiant may be legally capable of performing marriages in traditional venues, or they may be any other person or legal entity who the users desired to perform the ceremony. The marriage official may be a person capable of acting as a witness as required by some laws.

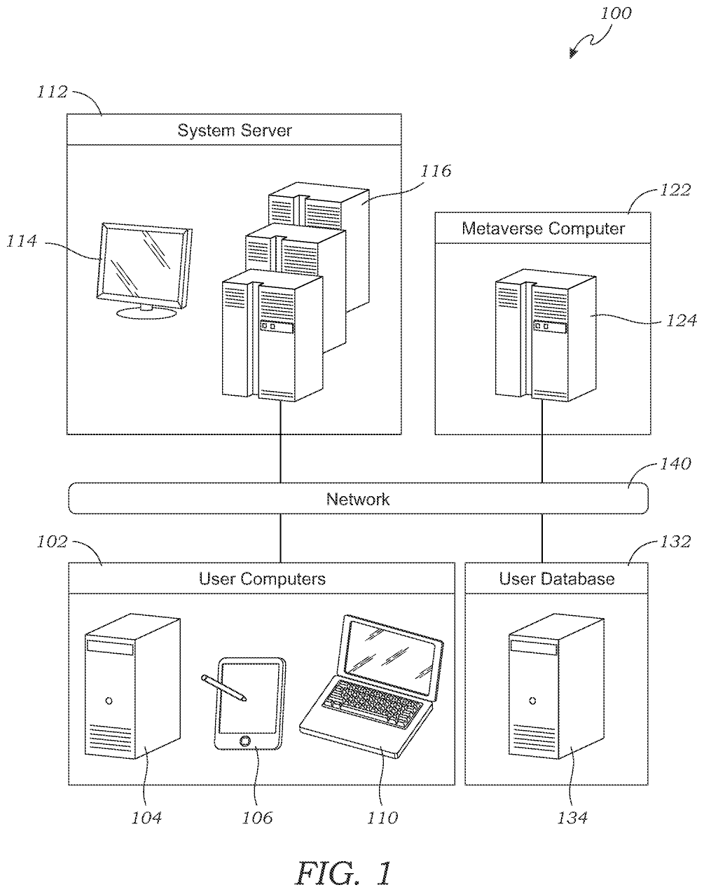

FIG. 1 is a block diagram of one embodiment of a blockchain-based marriage system 100 that embodies the present invention. As shown in FIG. 1, the system 100 may include user computers 102 that are adapted for use by individuals wishing to use the system 100. The user computers 102 may be any form of computing device, such as a desktop computer 104, a tablet computer 106, a laptop computer 110 (or any other form of computer device, e.g., smart phone, etc.).

In the embodiment of FIG. 1, each of the user computers 102 is connected to a computer network 140, where user computers 102 is capable of electronic communication with other computers connected to computer network 140. The system 100 may further include a system server 112, a metaverse computer 122, and a user database 132. As discussed above, the computer network 140 can include wired or wireless types of electronic communication for the transmission of computer data, including, for example, a local area network (LAN), a wide area network (WAN) (e.g., the Internet), and may consist of one or more cellular networks. Computer network 140 may utilize several protocols or networking standards to facilitate transmission of computer data, including, for example, Ethernet, TCP/IP protocols, the WiFi protocol, the Bluetooth protocol. TDMA, CDMA, GSM, iDen, and/or similar protocols or technologies known in the art.

The system server 112 is adapted for generating the blockchain-based documentation of a marriage, as described below. The system server 112 may include one or more server(s) 116 or other forms of computer device(s) that may be accessed by any of the other computers, including, for example, the user computers 102 over the computer network 140. The server(s) 116 may also be accessed by a local client device 114 by an operator of the system server 112, for the purposes of administering the system 100.

Similarly, the metaverse computer 122 may include a computing device 124 (e.g., server), connected to the computer network 140 for generating a metaverse (i.e., any form of virtual world) in which the marriage occurs. This may be integrated with the system server 112, or it may be a third party virtual world that already exists apart from the present invention.

The user database 132 may be installed on a further computing device 134, such as a server or other networked computing device, connected to computer network 140, or it may reside on one of the above-described computers, or it may be a third-party system that already includes the necessary user information (e.g., a form of digital wallet, or any other system where the users may have already registered and entered necessary personal information).

While the embodiment of FIG. 1 depicts only the above-described computers, many more computers, including many more computing devices, can be connected to, and operable to communicate via, computer network 140 in accordance with the embodiment disclosed herein. Each of the computers can include one or more processors, one or more computer memories RAM or ROM based computer storage), one or more communication interfaces (including a wired or wireless interface) for facilitating electronic communication over network 140, and/or one or more output devices (such as a screen, and an input device, such as a mouse, keyboard, touchscreen, or similar device). Alternatively, all of these computer functions could potentially be operated by a single piece of hardware, and there is no requirement that there be physical connection or separation of computer hardware. Any physical system designed by one skilled in the art consistent with this invention should be considered within the scope of the present invention.

The above-described computers can communicate over the computer network 140 in a client-server capacity, for example, using requests and responses via the Hyper Text Transfer Protocol (HTTP), Hyper Text Markup Language (HTML), and similar protocols and languages known in the art. The server 116 of the system server 112 can execute a webserver platform, including, for example, Java Server Pages (JSP), Active Server Pages (ASP).NET to facilitate client-server communication. In the present embodiment, the server 116 could receive requests from other computers, for example, the user computers 102, the metaverse computer 122, or the user database 132. For example, in one embodiment, the user computer 102 can send one or more requests to the system server 112 and receive related responses. The requests may be HTTP requests to retrieve one or more webpages or other form of data, where server(s) 116 host a website and/or database for responding with HTML, or similar web language technologies (e.g., JavaScript, CSS, etc.), for rendering the one or more webpages on the personal computer 110. In a similar embodiment, computing device 124 of the metaverse computer 122 may also send requests to and receive responses from servers(s) 116. In an embodiment where the user database 132 includes one or more servers 134, the servers 116 may also communicate via computer network 140 with servers 134, where the servers 134 may include information or services, such as user information (e.g., user information not readily available to server(s) 116, such as the user information) or other third-party information or services, where the server(s) 116 may access the information or services at the servers 134 via the computer network 140 in a client-server capacity. Any other similar methods and systems known to one skilled in the art should also be considered within the scope of the present invention.

The above-described computers form the blockchain-based marriage system 100, which can include a type of decentralized network. The blockchain-based marriage system 100 may be operable where each of the computers (or at least one of them) includes a blockchain program. The blockchain program can perform functions such as validating and relaying blockchain marriage entries as disclosed herein. In some embodiments, each of the computers may join the blockchain-based network by installing the blockchain program, thereby instantiating a computer as a blockchain enabled computer. In various embodiments, the blockchain-based network may coexist with the client-server based network, where each of the computers may perform both blockchain functionality and client-server functionality as described herein.

The system server 112 can be an administrator computer that can administer, manage, update, and/or maintain one or more blockchains or blockchain marriage entries in one or more blockchain networks, or it may utilize other blockchain systems. In at least some embodiments, the blockchain-based marriage system 100 can be decentralized, where no single computer can control a particular blockchain, but instead, where every computer can administer, manage, update, and/or maintain the blockchains in the network.

Because each computer in a blockchain-based network can be responsible for administering, managing, updating, and/or maintaining a blockchain, the blockchain-based network can serve as a distributed database, where no single computer maintains the blockchain and every computer can continually update and reconcile the blockchain, such that the blockchain is maintained and updated across the network. The blockchain may be public or private. In some embodiments, public blockchains include blockchains that can be accessed by any computer on the network. For example, in an embodiment where the computers of the blockchain-based network are public, any computer or user could access the blockchain, and, therefore blockchain marriage entries of blockchain-based network, as described below.

In other embodiments, private blockchains include blockchains that can be accessed only by certain computers, such as privileged computers, or by users of the blockchain-based network that provide security credentials (e.g., passwords) to access the blockchain. In other embodiments, a private blockchain may be made accessible where permission is provided to access the blockchain, such as, Where a user provides permission to access a blockchain including the user's personal information, as further described herein. For example, in an embodiment where the computers of the blockchain-based network are private, then only privileged computers or users could access the blockchain, and, therefore blockchain marriage entries of the blockchain-based network.

Storing the marriage data entries via a blockchain-based network can provide enhanced security over a storing data in traditional centrally located database, by including eliminating risks that conic with data being held centrally. For example, typical blockchain-based networks lack centralized points of vulnerability for computer hackers to attack. Specifically, no centralized version of this information exists for a hacker to corrupt. Instead, each of the computers maintains a copy that can be analyzed and checked against the copies in the other computers in order to reconcile a true version.

In addition, blockchain-based network security methods can use encryption technology. Users identify themselves in a blockchain-based network with a blockchain ID. In some embodiments, the blockchain ID is an encryption-based public key. A public key can be a cryptographic key that is associated with a private key that together form a user's public-private key pair. The public-private key pair can be used to execute marriage entries on a blockchain as described herein. In some embodiments, for example, a user's public key can be a long, randomly-generated string of numbers, which serves as a user's address on in a blockchain-based network. A user may engage in manage entries on the blockchain-based network, where the marriage entries gets recorded in the blockchain as belonging to that address, e.g., as associated with that user's public key.

In various embodiments, a user's private key can act as the user's password that gives its owner access to their marriage entries or other digital assets as stored on the blockchain on the blockchain network. A user typically keeps the private key confidential to prevent other blockchain users from altering or viewing the uses blockchain-based information or making new marriage entries not authorized by the user.

A public-private key pair can be generated for any of the computers using the aforementioned blockchain program, for example, after the blockchain program is installed on a computing device at a particular computer. In one embodiment, for example, the user computer 102 can generate its public-private key pair when the blockchain program is installed on the user computer 102. In some embodiments, a public-private key can be used to authenticate blockchain marriage entries, for example, to verify that a marriage data entry came from a particular blockchain user and that the blockchain marriage data entry has not been modified in the blockchain-based network 100. For example, a first user at the user computer 102 can, via the blockchain program, generate a public-private key pair as described herein. The first user can use his or her private key, via the blockchain program, to digitally sign, and, therefore authenticate a marriage data entry on the blockchain-based network. In some embodiments, each user can transfer data to another user by digitally signing a hash of the previous marriage data entry and the public key of the other user and adding these to the end of the blockchain. Users can verify the signatures of the blockchain marriage entries in each block linked in a blockchain to verify the chain of ownership from one user to the next.

For example, in an embodiment regarding the blockchain-based marriage system 100, a marriage data entry may be created to document when a first user marries a second user, as witnessed and officiated by a marriage officiant. Each of the parties can sign the marriage data entry with his or her private key, and the marriage officiant can similarly sign. For each user (and similarly for the marriage officiant), the private key will generate the user's digital signature for the marriage data entry. The system server 112, using the blockchain program, can then submit the blockchain marriage data entry to the blockchain-based network, where it may be added to the relevant blockchain in the blockchain network. Any party with the first user's public key can then verify (by using its own blockchain program and the user's public key) that the marriage data entry was actually created by the user because only the user's public key can correctly decipher the user's digital signature, thereby providing proof of authenticity for the marriage data entry.

In some embodiments, the blockchain-based marriage system 100 can check the consistency of existing and new marriage entries, and information therein on a periodic basis. In some embodiments, for example, any computer on the blockchain-based network can reconcile every existing or new marriage data entry in a blockchain, or in several blockchains, stored in each of the computers in predetermined intervals (e.g., 10 minutes), where each computer communicates with other computer to verify that the marriage data entries are consistent in each computer of the network.

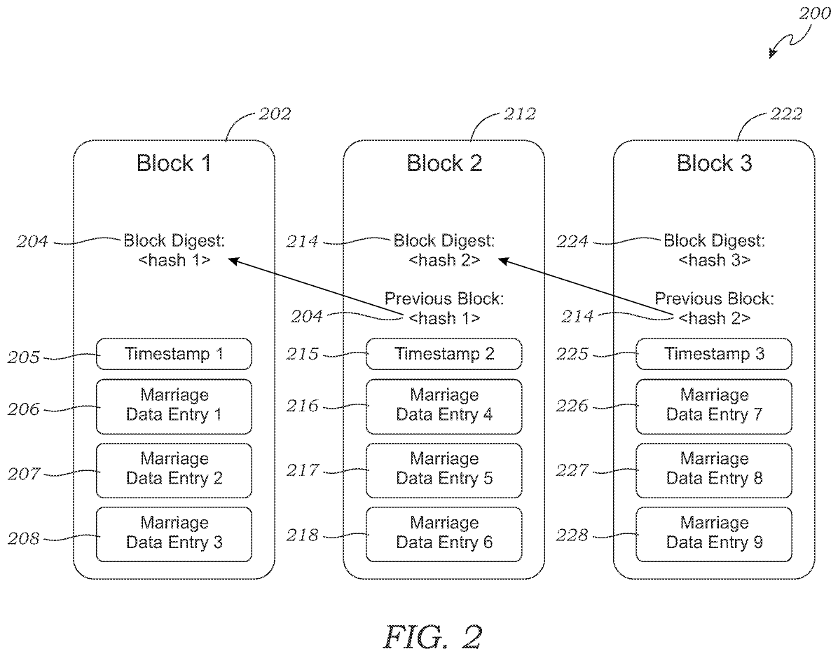

FIG. 2 is a block diagram of a blockchain 200 generated by the blockchain-based marriage system 100 of FIG. 1. As shown in FIG. 2, in one embodiment the blockchain 200 includes a chain of blocks (in this case three blocks are illustrated, Block 1 202, Block 2 212, and Block 3 222), each block containing one or more marriage data entries, in this case marriage data entry 1 206, marriage data entry 2 207, and marriage data entry 3 208 (which are shown in more detail as example marriage data entry 400 in FIG. 4).

While the blockchain is depicted with three blocks, where each blockchain contains three entries each, blockchain 200, or any given blockchain as contemplated herein, may consist of many more blocks with various numbers of marriage data entries, depending upon the requirements of the users of the system.

As shown in FIG. 2, each block can include marriage data entries from a particular time interval (e.g., all new blockchain marriage entries 400 grouped every 10 minutes, or on a particular day, or any other period of time deemed suitable). Each of the marriage data entries can be associated with a separate and unique entry ID. For example, Block 1 202 could consist of marriage data entry 1 206, marriage data entry 2 207, and marriage data entry 3 208, where each of marriage entries 1-3 (206-208) may have separate marriage data entry IDs and could have been analyzed and stored by a blockchain-based network in a first specific time interval.

Similarly, Block 2 212 could consist of marriage data entry 4 216, marriage data entry 5 217, and marriage data entry 6 218, where each of marriage entries 4-6 (216-218) may have separate marriage data entry IDs and could have been analyzed and stored by a blockchain-based network in a second time interval.

In addition, Block 3 222 could consist of marriage data entry 7 226, marriage data entry 8 227, and marriage data entry 9 228, where each of marriage entries 7-9 (226-229) may have separate marriage data entry IDs and could have been analyzed and stored by the blockchain-based marriage system 100 (of FIG. 1) in a third time interval.

Block 2 is linked to Block 1 using a block digest (e.g., Block Digest 204) as described further herein. In addition, Block 3 could then be linked to Block 2 using a block digest (e.g., Block Digest 214) as described further herein. Accordingly, the linked Blocks 1-3 (202, 212, 222) form blockchain 200. The block digests 204, 214, and 224 of Block 1 202, Block 2 212, and Block 3 222, respectively, link the each of the blocks together, using blockchain technology known in the art. In some embodiments, as depicted in FIG. 2, the block digests (204, 214, and 224) may each include a hash value that serves as a digital proof of work for the block. In one embodiment, the hash value may be determined by the blockchain-network computers, where the hash value is the solution to a computationally expensive math problem that includes as input all the text from several new unverified marriage entries, plus the digest of the most recent block, plus a random value. The input values may be used in a hash function, such as SHA-256, to generate the hash value. As depicted in FIG. 2, each block may store the hash value of a previous block creating a link from one block to the next, and, therefore creating a blockchain. For example, Block 212 includes its own hash value 214 and also the hash value 204 of the previous Block 1 202, such that a link is established in the blockchain 200. Similarly, Block 3 222, includes its own hash value 224 and also the hash value 214 of the previous Block 2 212, such that a further link is established in the blockchain 200. Block 1 is depicted with no previous hash, which, in some embodiments indicates that Block 1 is the genesis, or first, block in the chain that each of the further blocks, including Block 2 212 and Block 3 222 link back to either directly or indirectly as shown for FIG. 2.

In some embodiments, the hash value may have a preferred format, such as a leading number of zeroes for the hash value. In such embodiments, the blockchain computers may compete to determine the correctly formatted hash value, where the first computer to compute the hash value may receive a reward, such as a bitcoin (or other form of crypto-currency, or any other form of reward desired). Assuming the new block is valid, it can become a part of the block chain.

Each of the blocks 202, 212, and 222 (and others) may include a timestamp (205, 215, and 225, respectively, in this case) which is based upon the time/date at which the block was created.

In various embodiments herein, new entries are grouped into blocks on a periodic basis to create or update blockchains in the blockchain-based network (e.g., network 100), where each block can consist of one or more entries that have been executed in that time period. A next group of entries can then be executed in the next time period and so on, each time period creating a new block to add to a blockchain in the blockchain network. Accordingly, multiple blocks of related entries can be linked together thereby creating a blockchain as described herein. Thus, data or information embedded within a blockchain is embedded within the network as a whole. In addition, as described herein, in some embodiments, the blockchain can be public or private based on the network within it is stored. As described herein, the data within the network can be difficult for a hacker or other intruder to corrupt because the data is redundantly stored in various computers, which each provide a check-and-balance on each other and also serve as a backup in the event one or more of the other computers fail. Furthermore, each block is integrated with adjacent blocks, so that changing one block would necessitate changing all of the blocks in the blockchain. Since it would be nearly impossible to simultaneously change all of the blocks in the blockchain, on all of the computers in the network, this makes hacking and modifying a blockchain very difficult if not nearly impossible to achieve.

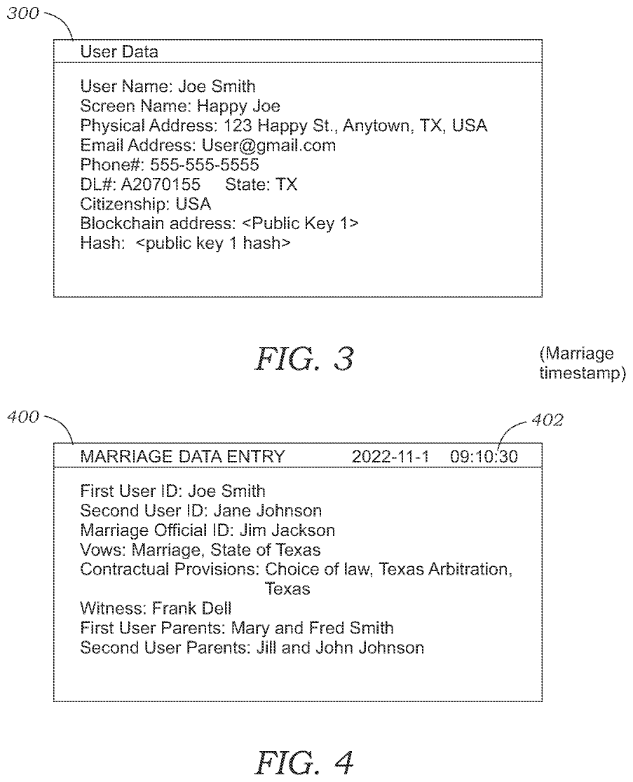

FIG. 3 is one embodiment of user data 300 captured for each user. As shown in FIG. 3, in one embodiment the user data 300 is stored on one or more computer memories of the user database 132 (or, alternatively, the system server 112) shown in FIG. 1, or other computer according to the knowledge of one skilled in the art. As shown in FIG. 3, the user data 300 includes user information 306 associated with a user, such as the user's full legal name, a screen name (or other alias), his or her physical address, the user's email address, and phone number. Other information may be included about the user, e.g., an account number, social security number, blockchain public key, etc.

The data or other information associated with the user data 300 may be stored in memory via one or more databases, such as the user database 132, in the form of a relational database, including an Oracle or MySQI, database, or a NoSQL, type database, such as MongoDB database, or any other suitable data structure known in the art. In some embodiments, the user data 300 may be maintained by every computer that the user account is associated with, such as every blockchain wherein the user account is associated with a marriage data entry. In another embodiment, the user account may be maintained only by the computer associated with the user, or with a third-party system (such as a digital wallet for example).

FIG. 4 is one embodiment of a marriage data entry 400 that may be incorporated in the blockchain of FIG. 2. In the embodiment of FIG. 4, the marriage data entry 400 may include information about the wedding, including information about the first and second users IDs, the marriage officiant ID, a timestamp 402 of the time of the completion of the marriage. It may also include marriage vows and contractual terms agreed upon by the first and second users if this is desired. Additional information may include information about the domiciles of the users, a choice of law under which the marriage contract is to be governed, a choice of forum, and any other contractual terms that may be desired (e.g., arbitration or mediation clauses, term, terms of termination, etc.).

The marriage data entry 400 may also include information about witnesses to the marriage, and information about parents of each of the users (parent's full legal names, citizenship, addresses, email, driver's license number, social security number, public key, etc.), and any other information that may be helpful in forming a legal marriage. The marriage data entry 400 may also include a certificate of divorce or a death certificate, if one of the users had been previously married.

The marriage data entry 400 may also include blockchain-based information, such as the user's blockchain address on a given blockchain network, such as the blockchain-based network. In some embodiments, the user's blockchain address can be the user's public key used to execute blockchain marriage entries on the blockchain network as described herein. The user's blockchain address can associate the user with marriage entries that that the user executed in a blockchain network. It may also include a hash value of the blockchain address, where, for example, the hash value is a hash of the public key. In some embodiments, the hash value can serve as a shortened address compared with the user's blockchain address (e.g., public key).

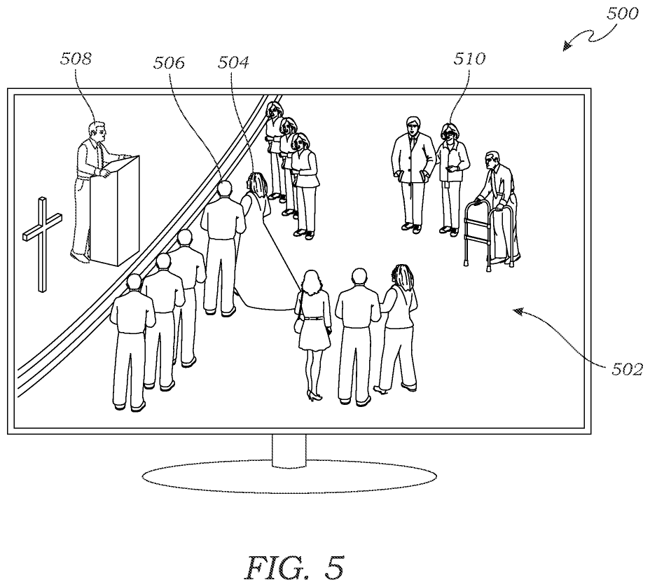

FIG. 5 is a screen capture of a metaverse 500 in which a marriage is being performed. As shown in FIG. 5, the metaverse computer 122 shown in FIG. 1 generates a virtual location 502 in which the marriage can occur. The virtual location 502 may be a traditional church or similar religious location, or it may be any other location that may be desired (e.g., a beach, a beautiful forest, another planet, etc.).

The virtual location 502 provides a place for the first avatar 504 (of the first user), the second avatar 506 (of the second user), and the third avatar 508 (of the marriage officiant) to interact and have the ceremony, in front of any witnesses 510 (in any form of avatars, if desired). This may follow traditional marriage ceremonies, with wedding vows being spoken or otherwise delivered by the users, or it may include any new ceremonies that may be desired by the users. Since the virtual location 502 and all of the avatars are completely digital, the particular embodiment that is used may vary depending on the creativity of the people operating the system 100, and the users and other associated parties.

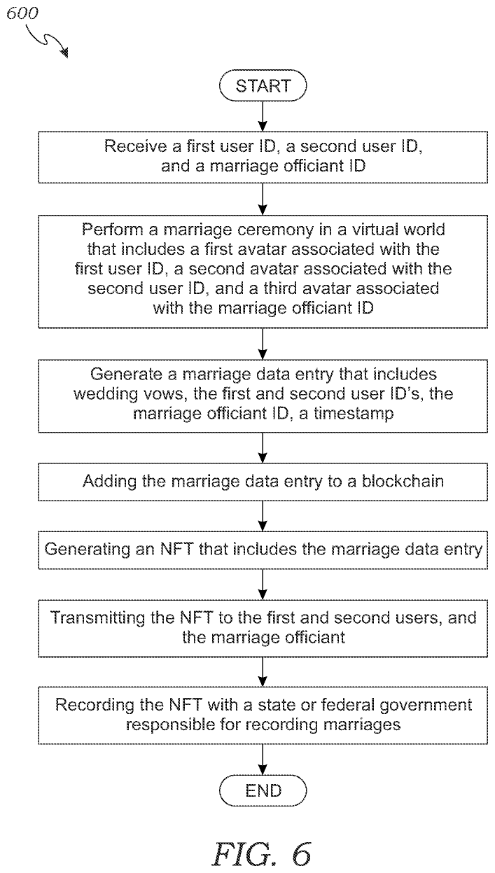

FIG. 6 is a flow diagram 600 illustrating the operation of the blockchain-based marriage system 100 (of FIG. 1). As shown in FIG. 6, the system 100 shown in FIG. 1 utilizes the computers described above to receive information about the users and all other participants. The metaverse computer then generates the metaverse (any form of virtual world) in which the users can engage in the ceremony. The metaverse includes the first avatar associated with the first user ID, the second avatar associated with the second user ID, and the third avatar associated with the marriage officiant ID (along with any other parties, witnesses, friends, parents, and at least one marriage officiant). The first, second, and third avatars are then able to interact within the metaverse to engage in a marriage ceremony.

At some point in the ceremony, such as after vows are given (or other form of consent), the marriage report of the marriage ceremony that was performed in the metaverse is transmitted to the computer (e.g., the system server 112 of FIG. 1) responsible for final processing of the marriage. Upon receipt of the marriage report, a marriage data entry is generated (the marriage data entry including the first and second user IDs, the marriage officiant ID, and any other information. The marriage data entry is then added to the blockchain.

The system 100 then performs the steps of creating a block that includes the marriage data entry, as discussed above. The system may also generate a timestamp that indicates the time that the block is being created, and incorporate the timestamp into the block, and adding the block to the blockchain.

The system server may also perform the following additional steps of generating an NFT that includes the marriage data entry, and transmitting the NFT to each of the first and second users (and potentially other parties, such as the officiant. The NFT may also be transmitted to a government agency (e.g., county clerk, Federal registrar, registration system of another country, or any other entity desired) responsible for recording marriage licenses.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean +/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A blockchain-based marriage system for performing a marriage in a metaverse between a first user and a second user, officiated by a marriage officiant, the system comprising:
a user database that includes a first user ID associated with the first user, a second user ID associated with the second user, and a marriage officiant ID associated with a marriage officiant;
a metaverse computer that includes a computer processor and a computer memory, the computer memory storing executable code for performing the following steps:
generating the metaverse;
generating within the metaverse a first avatar associated with the first user ID, a second avatar associated with the second user ID, and a third avatar associated with the marriage officiant ID;
enabling the first, second, and third avatars to interact within the metaverse to engage in a marriage ceremony; and
transmitting a marriage report of the marriage ceremony that was performed in the metaverse; and
a system server that includes a computer processor and a computer memory, the computer memory storing executable code for performing the following steps:
receiving the marriage report;
generating a marriage data entry in response to the marriage report, the marriage data entry including the first and second user IDs, the marriage officiant ID; and
adding the marriage data entry to a blockchain.

2. The blockchain-based marriage system of claim 1, wherein the system server performs the following additional steps:
generating an NFT that includes the marriage data entry; and
transmitting the NFT to each of the first and second users.

3. The blockchain-based marriage system of claim 2, further comprising a step of transmitting the NFT to a government agency responsible for recording marriage licenses.

4. The blockchain-based marriage system of claim 1, wherein the system server performs the following additional steps:
creating a block that includes the marriage data entry;
generating a timestamp that indicates the time that the block is being created;
incorporating the timestamp into the block; and
adding the block to the blockchain.

5. A method for performing a marriage in a metaverse between a first user and a second user, officiated by a marriage officiant, the method comprising the steps of:
providing a user database that includes a first user ID associated with the first user, a second user ID associated with the second user, and a marriage officiant ID associated with a marriage officiant;
providing a system server that includes a computer processor and a computer memory, the computer memory storing executable code for performing the following steps:
receiving a marriage report;
generating a marriage data entry in response to the marriage report, the marriage data entry including the first and second user IDs, the marriage officiant ID; and
adding the marriage data entry to a blockchain.

6. The method of claim 5, wherein the system server performs the following additional steps:
generating an NFT that includes the marriage data entry; and
transmitting the NFT to each of the first and second users.

7. The method of claim 6, further comprising a step of transmitting the NFT to a government agency responsible for recording marriage licenses.

8. The method of claim 5, wherein the marriage data entry further includes the marriage officiant ID, and a marriage timestamp.

9. The method of claim 2, wherein the metaverse is generated by a metaverse computer.

10. The method of claim 2, wherein the metaverse is generated by a metaverse computer that is physically separate from the system server, and wherein communications between the metaverse computer and the system server is via a global computer network.

11. A method for performing a marriage in a metaverse between a first user and a second user, officiated by a marriage officiant, the method comprising the steps of:
providing a user database that includes a first user ID associated with the first user, a second user ID associated with the second user, and a marriage officiant ID associated with a marriage officiant;
providing a metaverse computer that includes a computer processor and a computer memory, the computer memory storing executable code for performing the following steps:
generating the metaverse;
generating within the metaverse a first avatar associated with the first user ID, a second avatar associated with the second user ID, and a third avatar associated with the marriage officiant ID; and
enabling the first, second, and third avatars to interact within the metaverse to engage in a marriage ceremony;
providing a system server that includes a computer processor and a computer memory, the computer memory storing executable code for performing the following steps:
receiving a marriage report of the marriage ceremony that was performed in the metaverse;
generating a marriage data entry that includes the marriage report and the first and second user IDs, the marriage officiant ID, and a timestamp;
adding the marriage data entry to a blockchain;
generating an NFT that includes the datablock; and
transmitting the NFT to the first and second users.
